(19) United States
(12) Patent Application Publication
(10) Pub. No.: US 2015/0220856 A1
(43) Pub. Date: Aug. 6, 2015

(54) METHODS AND SYSTEMS FOR DETECTION AND ANALYSIS OF COST OUTLIERS IN INFORMATION TECHNOLOGY COST MODELS

(71) Applicant: VMware, Inc., Palo Alto, CA (US)

(72) Inventors: Al Yaros, Herzliya (IL); Tzvika Stein, Herzliya (IL); Sagi Bernstein, Herzliya (IL); Matan Ghuy Waron, Herzliya (IL); Eyal Cohen, Herzliya (IL)

(73) Assignee: VMware, Inc., Palo Alto, CA (US)

(21) Appl. No.: 14/169,724

(22) Filed: Jan. 31, 2014

(51) Int. Cl. G06Q 10/06; G06Q 40/00

(52) U.S. Cl. CPC G06Q 10/063; G06Q 40/12

(57) ABSTRACT

Computational methods and systems for detecting cost outliers in various information technology (“IT”) services provided an IT service provider are described. In one implementation, bills of IT generated for each billing period are converted into corresponding cost-flow models with expense nodes. Each expense node represents a cost for a particular IT services purchased during a billing period. The method searches the expense nodes over the billing periods for cost outliers, and rank orders the cost outliers. The method then analyzes the cost outliers in order to identify a possible root cause for each cost outlier. The rank order and possible cost outliers are stored in a data-storage device.

### TECHNICAL FIELD

The present disclosure is directed to computational systems and methods for detecting and analyzing cost outliers in information technology services.

### BACKGROUND

Minimizing information technology (“IT”) cost while maximizing the value of IT services is an objective of IT business management. In recent years, IT business management tools, such IT cost transparency, have been developed to enable IT service providers a way to model and follow the total and itemized cost of delivering and maintaining IT services provided to an enterprise. IT cost transparency integrates financial information, such as labor cost, software licensing cost, hardware cost and depreciation, and data center facilities charges, and combines the integrated financial information with operational data, such as ticketing, monitoring, asset management, and project portfolio management systems, to provide a single, integrated view of IT cost by service, department, general ledger line item and project. In addition to following cost elements, IT cost transparency tracks utilization, usage, and operational performance metrics in order to provide a measure of return on investment to the enterprise. IT cost transparency generates a bill of IT, which is delivered to the enterprise. The bill of IT provides the enterprise with a detailed invoice of cost and value of the IT services they purchased. Preparing an effective bill of IT requires an in-depth understanding of the cost associated with delivering each IT service and the ability to accurately showback and chargeback these cost in a way the enterprise understands.

However, because the number of various IT services provided to an enterprise is typically very large and may span many months and years, it is often a daunting challenge for enterprise managers to track and identify individual cost outliers in the IT services they purchased. IT service providers and enterprises that purchase IT services seek computational systems and methods that identify individual cost outliers in various services provided by the IT service provider.

### SUMMARY

Computational methods and systems for detecting cost outliers in various information technology (“IT”) services provided an IT service provider are described. In one implementation, bills of IT generated for each billing period are converted into corresponding cost-flow models with expense nodes. Each expense node represents a cost for a particular IT services purchased during a billing period. The method searches the expense nodes over the billing periods for cost outliers, and rank orders the cost outliers. The method then analyzes the cost outliers in order to identify a possible root cause for each cost outlier. The rank order and possible cost outliers are stored in a data-storage device.

### DESCRIPTION OF THE DRAWINGS

FIG. 1 shows an example of an enterprise that receives information technology (“IT”) services from an IT service provider.

FIG. 2 shows an example of a bill of IT that presents an itemized list of IT services purchased by an enterprise.

FIG. 3 shows an example of a generalized computer system that executes methods for determining cost outliers.

FIG. 4 shows an example cost-flow model for a bill of IT shown in FIG. 2.

FIG. 5 shows an example cost-flow model for a labor node in FIG. 4.

FIG. 6 shows an example cost-flow model for a telecommunications node in FIG. 4.

FIG. 7 shows a series of cost-flow models generated for N payment periods.

FIGS. 8A-8C illustrate an example of cost-outlier detection for a set of costs associated with a particular expense node.

FIG. 9 shows an example of an adjacency matrix for the cost-flow model shown in FIG. 4.

FIG. 10 shows an example column unit vector associated with an expense with a cost outlier.

FIGS. 11A-11C show an example of two paths that lead from two cost outliers back to a root node.

FIG. 12 shows a flow control diagram of a method for detecting cost outliers of IT costs.

FIG. 13 shows a flow-control diagram for the routine “outlier detection” called in block 1205 of FIG. 12.

FIG. 14 shows a flow-control diagram for the routine “rank outliers” called in block 1207 of FIG. 12.

FIG. 15 shows a flow-control diagram for the routine “suggest cause for outliers” called in block 1208 of FIG. 12.

### DETAILED DESCRIPTION

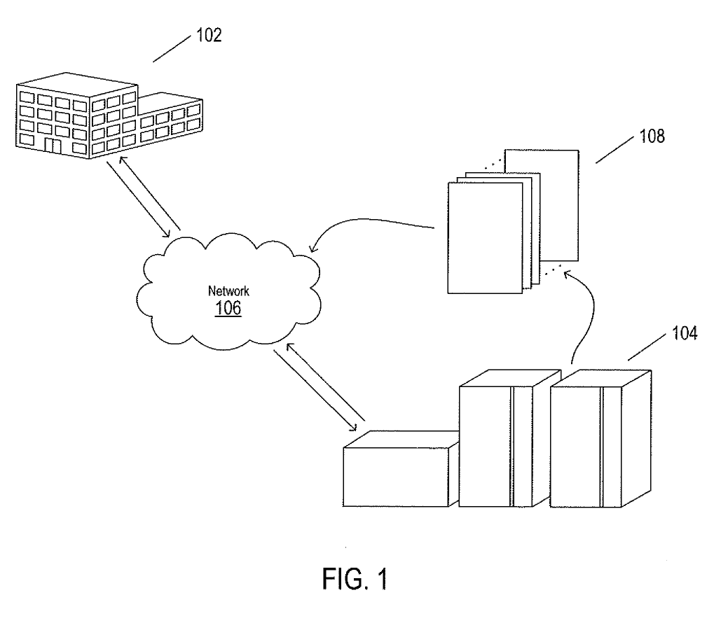

This disclosure presents computational methods and systems for detecting cost outliers in various information technology (“IT”) services purchased by an enterprise from an IT service provider. FIG. 1 shows an example of an enterprise 102 that receives IT services from an IT service provider 104. The enterprise 102 may be a business, an individual, a government agency, or any non-profit or for-profit organization. The IT service provider 104 maintains an infrastructure of computers, servers, data-storage devices, telecommunications, an internal network, virtual machines (“VMs”), virtual servers (“VSs”), email, and numerous other data processing and data storage services. The enterprise 102 purchase IT services from the IT service provider 104 and accesses the services via a network 106, such as the Internet. For example, the IT service provider 104 may provide hosting services for various applications used by the enterprise 102. The IT service provider 104 may also provide private and public cloud computing services. For example, the IT service provider 104 may maintain a cloud infrastructure accessed solely by the enterprise 102, or the provider 104 may maintain a cloud infrastructure accessed by users of services offered by the enterprise 102 over the network 106. The IT service provider 104 periodically generates a bill of IT that itemizes the IT services purchased by the enterprise 102. Each bill of IT provides the enterprise 102 with an itemized list of expenses, costs, and allocation of the IT services purchased.

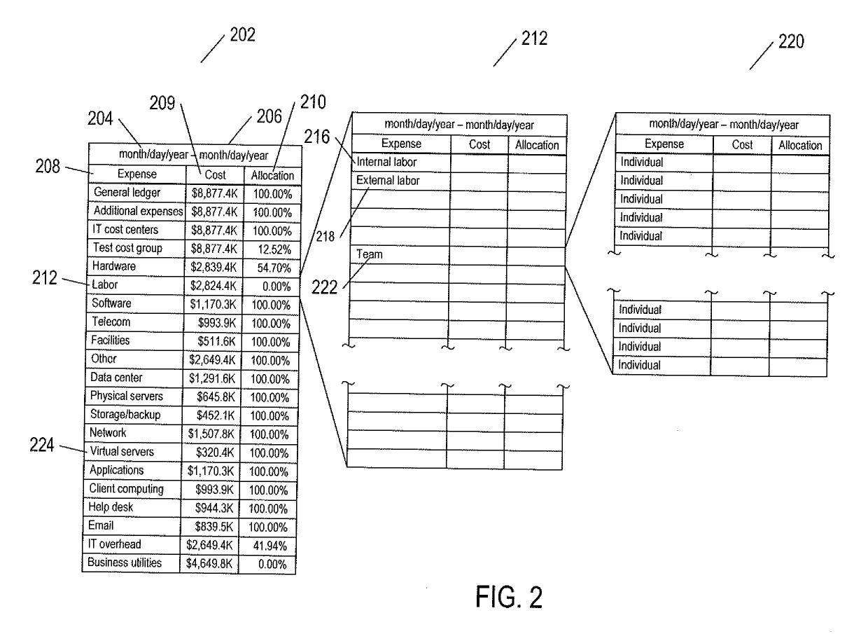

FIG. 2 shows an example of a bill of IT 202 that presents a high-level itemized list of IT services purchased by an enterprise. The bill of IT 202 is time stamped with period beginning date 204 and period ending data 206 that indicates the period of time over which the services listed in the bill of IT 202 were purchased. In this example, the bill of IT 202 is organized into three separate columns 208-210 correspondingly labeled “Expense,” “Cost,” and “Allocation.” The expense column 208 is a highest level list of the IT services purchased by an enterprise; the cost column 209 is a list of the cost of each IT service listed in column 208; and the allocation column 210 is a list of the allocation of cost of each IT service listed in column 208. Each expense listed in column 208 may actually represent the total cost of a subset of expenses that added together make up the expense listed in column 208. For example, FIG. 2 includes a separate bill of IT 212 for labor expense 214 listed in column 208. The bill of IT 212 is an itemized list of the expenses that combine to form labor expense 214 in column 208. The bill of IT 212 reveals that labor 214 is composed of internal labor 216 and external labor 218. Internal labor 216 represents the total cost of labor provided by employees of the IT service provider, and external labor 218 represents the total cost of labor provided by contractors of the IT service provider. In this example, the bill of IT 212 also reveals that the labor is divided into teams of employees and contractors in order to show the cost associated with each team. FIG. 2 also includes a bill of IT 220 that reveals the cost and allocation per employee or contractor within each team, such as team 222.

The cost of each IT service from the highest to the lowest cost level is recorded over a number of periods creating a set of costs for each IT service item purchased by an enterprise. For example, cost of VSs 224 is recorded for each period to form a set of costs associated with VSs 224, and the cost of each VS summed to give the VSs 224 are also recorded for each period to form a set of costs associated with each VS. Because each expense in the bill of IT 202 may actually represent a subset of expenses that, in turn, may each represent a more refined subset of expenses, an enterprise that would like to identify anomalous IT service costs is faced with a difficult and expensive task of having to sort through hundreds if not thousands of expenses collected over numerous periods. The methods and systems described below are directed to an automated computational approach that examines each set of costs associated with a particular IT service in order to identify cost outliers. A cost outlier is the cost that lies far away from, or deviates from, a subset of a set of costs associated with a particular IT service. Once the cost outliers have been identified, the methods and systems also analyze the cost outliers in order to provide the enterprise with a possible root cause for each cost outlier.

It should be noted at the onset that sets of cost data associated with each IT service and cost outlier data output from the systems and methods for detecting and analyzing cost outliers in the sets of cost data described below are not, in any sense, abstract or intangible. Instead, the cost and cost outlier data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

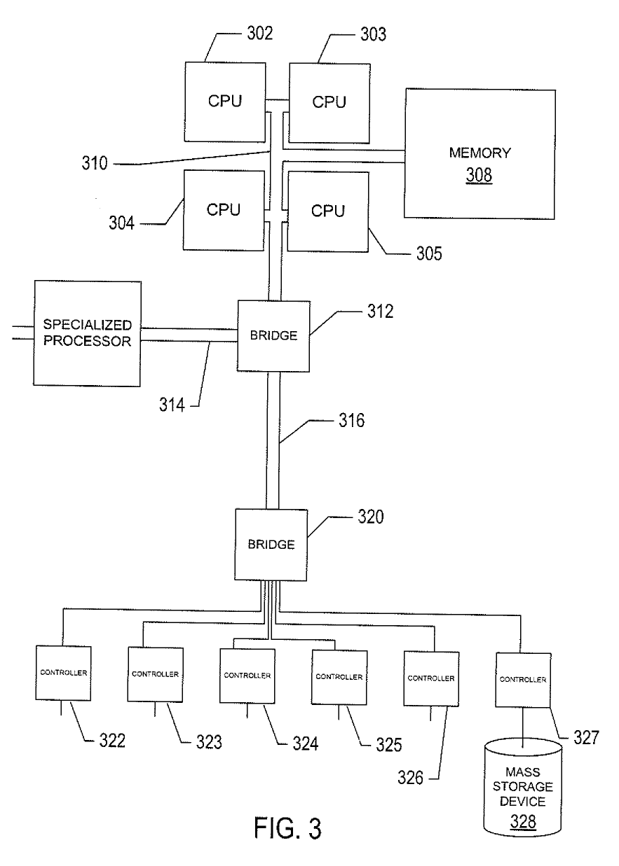

FIG. 3 shows an example of a generalized computer system that executes efficient methods for detecting cost outliers and therefore represents a data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 302-305, one or more electronic memories 308 interconnected with the CPUs by a CPU/memory-subsystem bus 310 or multiple busses, a first bridge 312 that interconnects the CPU/memory-subsystem bus 310 with additional busses 314 and 316, or other types of high-speed interconnection media, including multiple, high-speed serial interconnects. The busses or serial interconnections, in turn, connect the CPUs and memory with specialized processors, such as a graphics processor 318, and with one or more additional bridges 320, which are interconnected with high-speed serial links or with multiple controllers 322-327, such as controller 327, that provide access to various different types of computer-readable media, such as computer-readable medium 328, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 328 is a data-storage device, including electronic memory, optical or magnetic disk drive, USB drive, flash memory and other such data-storage device. The computer-readable medium 328 can be used to store machine-readable instructions that encode the computational methods described below and can be used to store encoded data, during store operations, and from which encoded data can be retrieved, during read operations, by computer systems, data-storage systems, and peripheral devices.

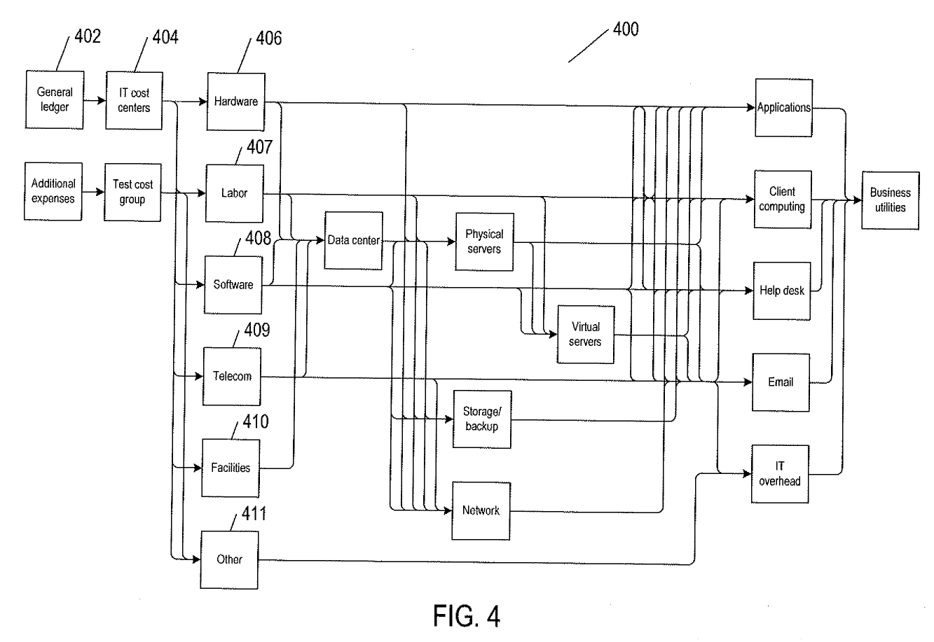

Methods and systems for identifying cost outliers generate a cost-flow model for each bill of IT. A cost-flow model is a directed acyclic graph that represents the flow of expenses. FIG. 4 shows an example cost-flow model 400 for the high-level bill of IT 202 shown in FIG. 2. The cost model 400 is a directed acyclic graph. Each node is identified as an expense node in the cost model 400 represents an expense or a row of the bill of IT 200 and is labeled according to the expense. For example, node 402 is labeled by the expense “general ledger” and represents the cost $8,877.4K and 100.00% allocation. The expense nodes are connected by directed edges that represent the flow of cost. For example, cost of the expense “general ledger” represented by node 402 flows to the IT cost centers represented by node 404. The cost of the IT cost centers 404 flows to hardware, labor, software, telecommunications, facilities, and other represented by nodes 406-411, respectively.

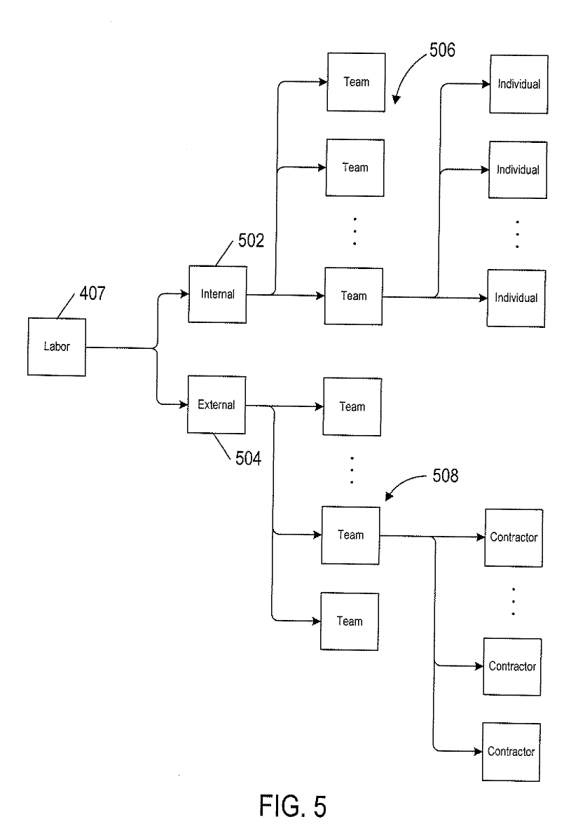

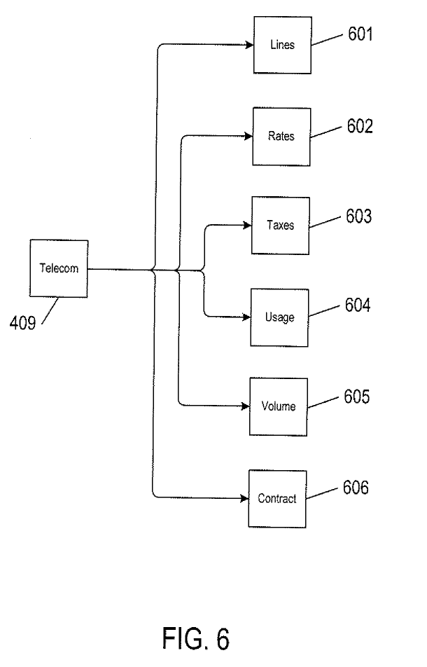

Because each expense in the bill of IT 202 may actually represent a subset of expenses as explained above with reference to FIG. 2, each node in the cost-flow model 400 may have an associated cost-flow model. FIG. 5 shows an example cost-flow model 500 for the expense node labor 407 in FIG. 4. The cost-flow model in this case is a directed tree graph. Expense nodes 502 and 504 represent internal and external labor, respectively, described above with reference to bill of IT 212 in FIG. 2. The cost-flow model includes nodes 506 that represent expense, cost, and allocation of teams of employees and nodes 508 that represent the expense, cost, and allocation of teams of contractors. FIG. 6 shows an example cost-flow model 600 for the expense node telecommunications 409 in FIG. 4. Expense nodes 601-606 represent expenses for lines, rates, taxes, usage, volume, and contract, respectively. The cost associated with each of these expenses represented by the nodes 601-606 combine to give the overall cost of telecommunications represented by node 409.

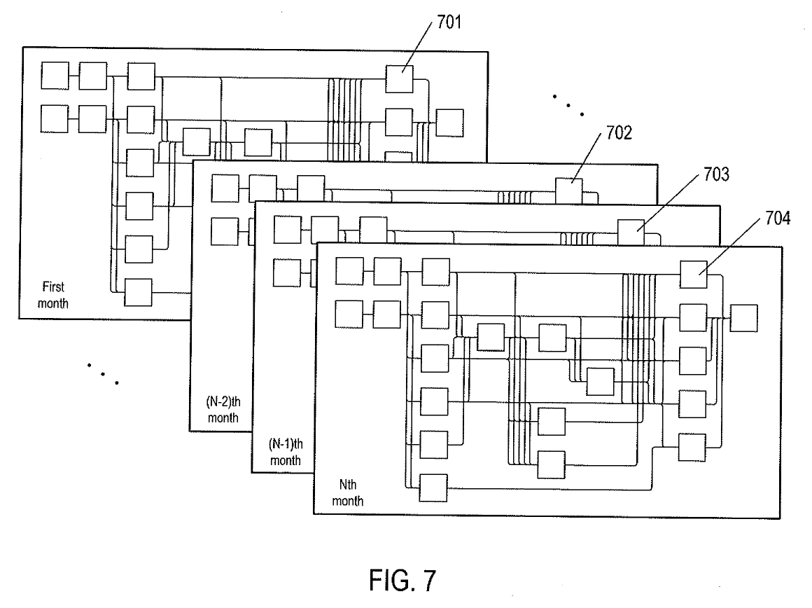

Cost-flow models are generated for each period in which a bill of IT is generated. FIG. 7 shows a series of high-level cost-flow models generated for each of N periods. For the sake of convenience only the high-level cost-flow models are represented in FIG. 7. Lower-level cost-flow models, such as cost-flow models 500 and 600, are also generated for each expense node of the high-level cost-flow models represented in FIG. 7. The cost-flow models are time stamped in order to identify the periods in which the cost-flow models are generated. For example, in FIG. 7, the cost-flow models are generated for N months. The costs associated with a particular expense node are collected over N periods to form a set of costs. For example, expense nodes, such as nodes 701-704, represent the expense “applications” in the N cost-flow models in FIG. 7. The costs associated with each of the application expense nodes are collected to form a set of application costs for the N periods. A set of costs may also be formed for each of the nodes in the lower-level cost-flow models. It should be noted that the sets of costs may not all contain N cost elements. Certain sets of costs may have fewer than N cost elements, because the expenses may not be incurred each period.

After a set of costs has been formed for each expense node over the N periods, outlier detection is used to find any cost outliers that may be present in each set of costs. It may the case that many sets of costs associated with different expenses do not have a cost outlier while other sets may have one or more cost outliers. The follow description presents one technique for identifying a cost outlier in a set of costs associated with an expense node. Consider a set of M cost points {xᵢ}ᵢ₌₁^{M} associated with an expense, where xᵢ=(Cᵢ, Pᵢ); Cᵢ is the cost of the expense at time period Pᵢ; and M is the number of periods over which the costs are collected (i.e., M≦N). In order to determine if a cost Cₚ is an outlier cost the method begins by calculating distances from the cost point xₚ to each of the cost points in the set {xᵢ}ᵢ₌₁^{M} to give:

{d(xₚ,xᵢ)}ᵢ₌₁^{M-1} (1)

The k cost points xᵢ with the k shortest distances in Equation (1) form a set of k-nearest neighboring cost points to the cost point xₚ. The set of k-nearest neighbor cost points is denoted by Nₚ (xₚ∉Nₚ) and is referred to as the neighborhood of cost point xₚ. The cost Cₚ is identified as an outlier cost when the cost point xₚ is outside the neighborhood of k-nearest neighbors as determined by:

$$\begin{matrix} d ( {x}_{p} , \overline{x} ) > \frac{k + 1}{k ( k - 1 )} {\sum }_{{x}_{i} ∈ {N}_{p}} d ( {x}_{i} , \overline{x} ) = \frac{{\overline{d}}_{{x}_{p}}}{{\overline{D}}_{{x}_{p}}} \\ where & ( 2 ) \\ \overline{x} = \frac{1}{k} {Σ}_{{x}_{i} ∈ {N}_{p}} {x}_{i} is the center of the neighborhood {N}_{p} ; & ( 3 a ) \\ {\overline{d}}_{{x}_{p}} = \frac{1}{k} {Σ}_{{x}_{i} ∈ {N}_{p}} d ( {x}_{p} , {x}_{i} ) is an average of the distance of the cost {x}_{p} & ( 3 b )\end{matrix}$$

to each cost the neighborhood Nₚ; and

$${\overline{D}}_{{x}_{p}} = \frac{1}{k ( k - 1 )} {Σ}_{{x}_{i .} {x}_{i ′} ∈ {N}_{p} , i \neq i ′} d ( {x}_{i} , {x}_{i ′} ) is an average distance between \qquad ( 3 c )$$

the costs in the neighborhood N.

In certain implementations, the distance d may be a Euclidean distance denoted by ∥•∥ or the square of the Euclidean distance ∥•∥². In other implementations, the distance d may be simply a function of costs. For example, d(xᵢ,xᵢ)=|Cᵢ−Cⱼ| and

$$\overline{C} = \frac{1}{k} {Σ}_{{c}_{i} ∈ {N}_{p}}$$

### Cᵢ in Equations (1)-(3).

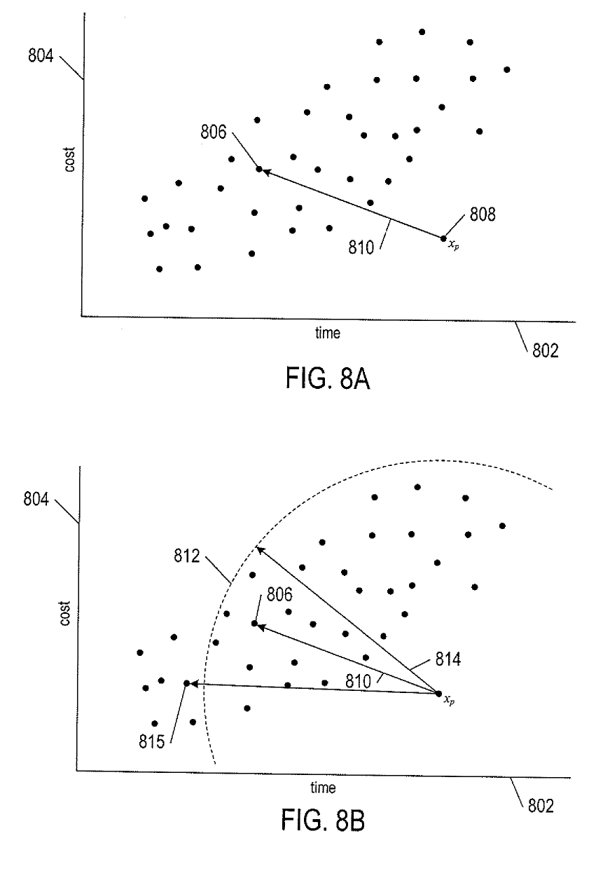

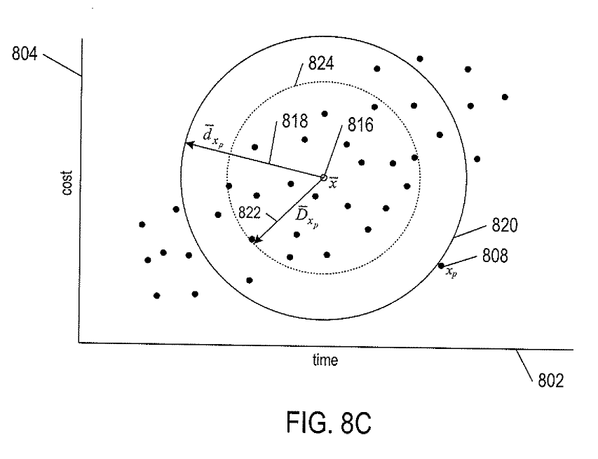

FIGS. 8A-8C illustrate an example of cost outlier detection for a set of costs associated with a particular expense. In FIGS. 8A-8C, horizontal axis 802 represents periods or time and vertical axis 804 represents cost. Solid dots represent cost points for a set of costs associated with a particular expense collected over M periods. In the example of FIGS. 8A-8C, M equals 38. Consider determining whether or not a particular cost Cₚ with cost point xₚ 808 is an outlier. The distance from the cost point xₚ 808 to each of the other M−1 cost points in the set of costs are calculated according to Equation (1). For example, directional arrow 810 represents the Euclidean distance from the cost point xₚ 808 to the cost point 806. The k cost points xᵢ with the k shortest distances to the cost point xₚ 808 are identified to form a neighborhood Nₚ composed of the k-nearest neighbor cost points to xₚ 808. In FIG. 8B, k equals 30 and dashed curve 812 represents a boundary between costs in the neighborhood N and cost in the compliment of the neighborhood N. Costs with the 30 shortest cost-point distances to the cost point xₚ 808 that are less than radial distance 814, such as cost point 806, are in the neighborhood N of cost point xₚ 808, while costs with a radial distance greater than radial distance 814, such as cost point 815, are in the compliment of the neighborhood Nₚ. In FIG. 8C, a point x̅ 816 identifies the center of the neighborhood Nₚ calculated according to Equation (3a); directional arrow 818 represents the average distance d̅ₓ_{ₚ} between from the cost point xₚ 808 to costs in the neighborhood Nₚ calculated according to Equation (3b), which is illustrated as the radius of a circle 820 centered on the point 816; and directional arrow 818 identifies the average distance D̅ₓ_{ₚ} between costs in the neighborhood Nₚ calculated according to Equation (3c), which is illustrated as the radius of a circle 824 centered on the point 816. According to Equation (2), when d(xₚ, x̅)> d̅ₓ_{ₚ}/ D̅ₓ_{ₚ}, the cost Cₚ may be considered an outlier.

In alternative implementations, a user selected tolerance, denoted by TOL, may be included in order to avoid classifying any cost with a cost point outside the neighborhood Nₚ as an outlier. For example, certain cost may be on the outside edge of the neighborhood Nₚ but should not necessarily be considered a cost outlier. As a result, in alternative implementations, the cost point xₚ is outside the neighborhood of k-nearest neighbors and the cost Cₚ may be identified as a cost outlier when

$$d ( {x}_{p} , \overline{x} ) > \frac{k + 1}{k ( k - 1 )} {\sum }_{{x}_{i} ∈ {N}_{p}} d ( {x}_{i} , \overline{x} ) + TOL = \frac{{\overline{d}}_{{x}_{p}}}{{\overline{D}}_{{x}_{p}}} + TOL \qquad ( 4 )$$

where TOL is a user selected tolerance.

After the cost outliers have been identified, the cost outliers are rank ordered. The cost outliers may be ranked according to

$$R ( {C}_{0} ) = {w}_{1} \cdot {C}_{0} + {w}_{2} \cdot d ( {x}_{{E}_{0}} , \overline{x} ) + {w}_{3} \cdot ( \frac{{C}_{0}}{T} \cdot 100 ) + {w}_{4} \cdot σ ( {E}_{0} ) \qquad ( 5 )$$

where

wᵢ are user selected weights;

Cₒ represents the value of the cost outlier at expense node Eₒ,

d(x_{E}_{ₒ}, x̅) is the distance described above;

$$( \frac{{C}_{0}}{T} \cdot 100 )$$

is the cost outlier percentage of the total cost, T, associated with the cost-flow model; and

σ(Eₒ) is the centrality of expense node Eₒ in the cost-flow model with outlier cost Cₒ.

The distance d(x_{C}_{ₒ}, x̅) may be the Euclidean distance ∥x_{C}_{ₒ}+ x̅∥, square of the Euclidean distance ∥x_{C}_{ₒ}− x̅∥², or |Cₒ− C̅|. The centrality may be calculated in any one of a number of different ways. One way of calculating the centrality σ(Eₒ) is given by:

σ(Eₒ)= 1̅((I−αA)⁻¹−I)·ē_{C}_{ₒ} (6)

where

A is an adjacency matrix for the cost-flow model;

α is a user selected constant (e.g., α=0.5);

1̅=[1, 1, . . . , 1, 1]^{T};

I is the identity matrix; and

ē_{C}_{ₒ}=[0, . . . , 0, 1, 0, . . . , 0]^{T}.

The adjacency matrix A is a square, symmetric matrix of “1's” and “0's,” where a “1” represents nodes of a graph connected by an edge and a “0” represents nodes that are not connected by an edge. The unit vector ē_{C}_{ₒ} is all zeros except for the element that corresponds to the node with cost outlier Cₒ.

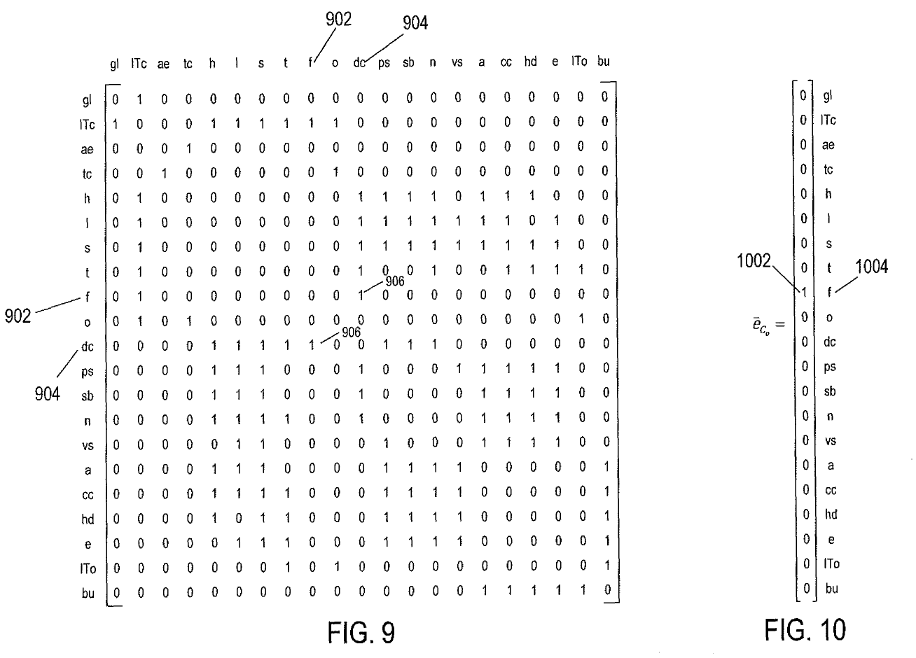

FIG. 9 shows an example of an adjacency matrix for the cost-flow model shown in FIG. 4. For the sake of convenience, one and two letter abbreviations are included along the top and side of the matrix to identify the nodes. For example, abbreviation “f” 902 represents the facilities node and abbreviation “dc” 904 represents the data center node. The “1” matrix elements represent nodes connected by an edge, and “0” matrix elements represent nodes that are not connected by an edge. For example, in FIG. 4, the facilities node is connected by an edge to the data center node which is represented by a “1” matrix elements 906.

FIG. 10 shows an example column unit vector ē_{C}_{ₒ} where the facilities is identified as a cost outlier Cₒ. The elements are identified by a column of one and two letter abbreviations that correspond to the order of the abbreviations used to identify nodes in of the adjacency matrix in FIG. 9. In this example, because the facilities cost is a cost outlier, the vector element 1002 corresponding to the facilities 1004 is a “1” and all other vector elements are “0.”

In an alternative implementation, the centrality σ(Eₒ) may be calculated according to:

$$σ ( {E}_{0} ) = \frac{1}{{λ}_{max} ( A )} \cdot {\sum }_{j = 1}^{n} {a}_{{jE}_{0}} \cdot {v}_{j} \qquad ( 7 )$$

where

λₘₐₓ(A) is the maximum eigenvalue of A;

v̅=[v₁, . . . , vₙ]^{T} eigenvector associated with λₘₐₓ(A); and

a_{jE}_{ₒ} matrix element of A.

After the cost outliers have been rank ordered according to Equation (5), a root cause for the cost outliers is suggested by examining the paths that lead from an expense node with a cost outlier to a root node. The methods and systems determine cost outliers that intersect the paths found. Each expense node associated with a cost outlier that is located along one or more of these paths is identified as a candidate for a root cause.

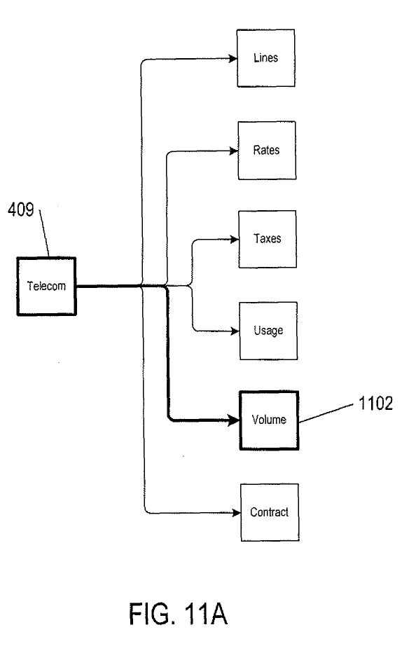

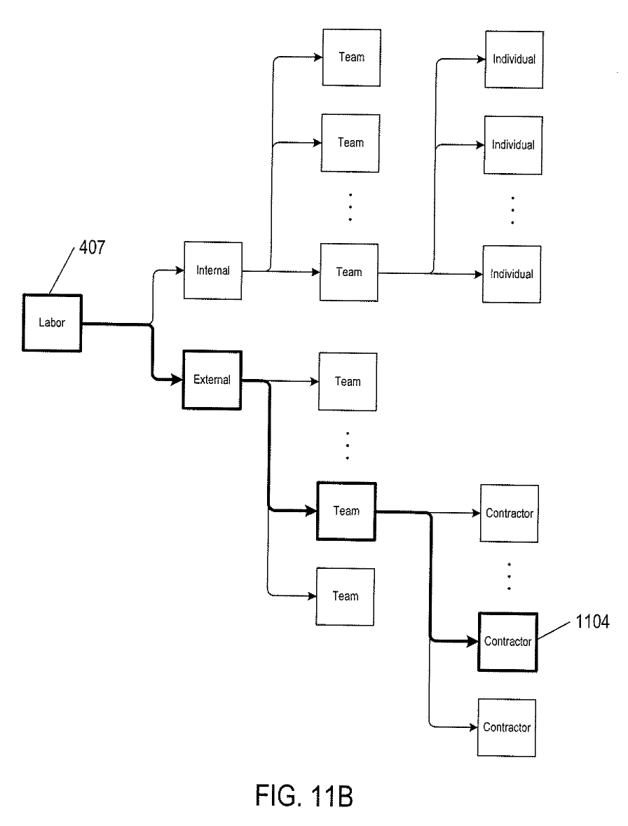

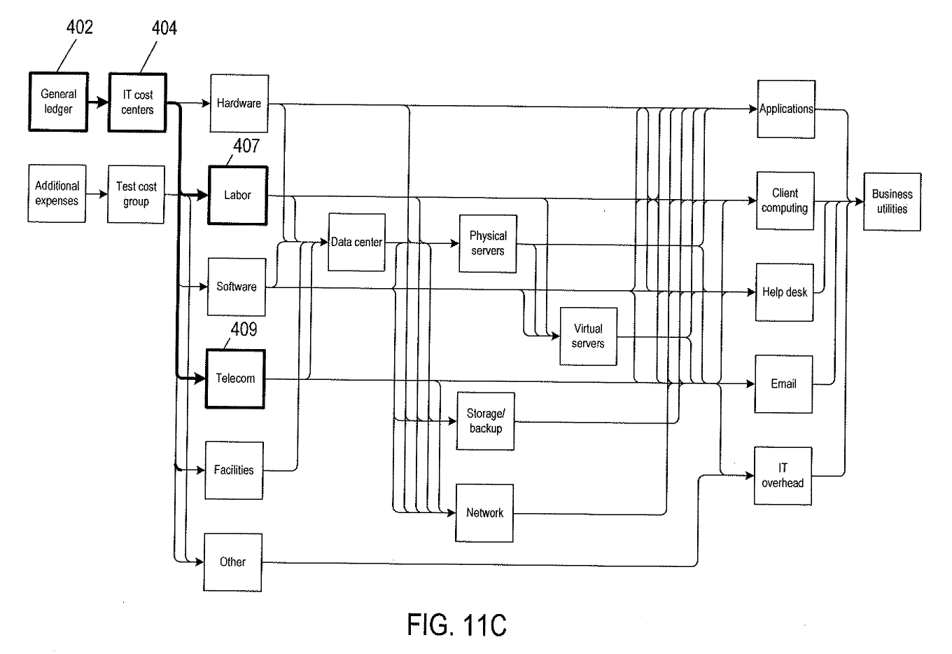

FIGS. 11A-11C show an example of two paths within cost-flow models that lead from two cost outliers back to a root node. Heavy shading is used to identify the two paths that begin at leaf nodes in FIGS. 11A and 11B with cost outliers back to a root node in FIG. 11C. FIG. 11A shows an example of a telecommunications cost-flow model for the telecommunications node 409. In this example, highlighted volume node 1102 is a cost outlier and bolding identifies a path back to telecommunications node 409. FIG. 11B shows a labor cost-flow model for the labor node 407. In this example, highlighted contractor node 1104 is a cost outlier and bolding represents a path back to labor node 409. FIG. 11C shows two paths that lead from telecommunications node 409 and labor node 407 back to the general ledger root node 402. In this example, any cost outliers that intersect these two paths are identified. Each node with a cost outlier that is located along one or both of these paths is presented to a user as a candidate for a root cause.

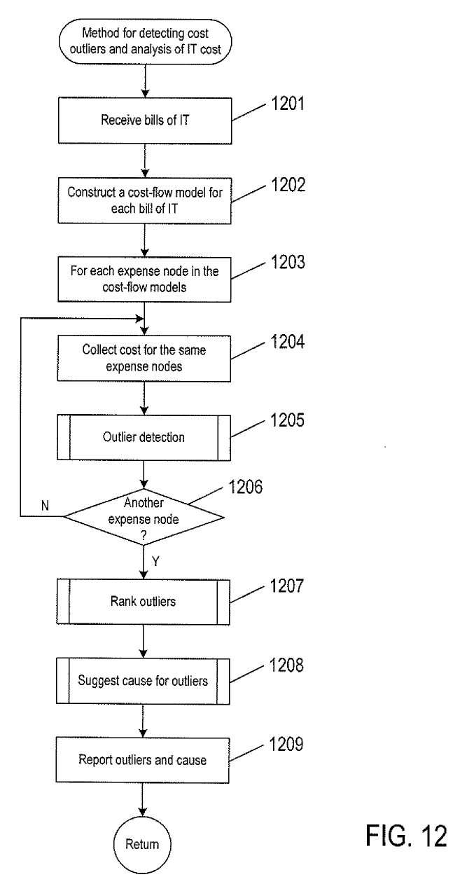

FIG. 12 shows a flow-control diagram of a method for detecting cost outliers of IT costs. In block 1201, N bills of IT are collect for N billing periods. In block 1202, a cost-flow model is constructed for each of the N bills of IT. The cost-flow models may be in the form of directional acyclic graphs, as described above with reference to the examples in FIGS. 4-6. In block 1203, a for-loop repeats the operations of blocks 1204-1206 for each expense node in the cost-flow models. In block 1204, costs are collected for the same expense node from all of the cost-flow models. In block 1205, a routine “outlier detection” is called to detect one or more cost outliers in the set of costs. In block 1206, when all the expense nodes have been considered, the method proceeds to block 1207, otherwise the operations in blocks 1204-1205 are repeated for another expense node. In block 1207, a routine “rank outliers” is called to rank order the cost outliers and return a list of the cost outliers. In block 1208, a routine “suggest cause for outliers” is called to identify potential causes for the cost outliers. In block 1209, the list of rank ordered cost outliers is presented to the user and the potential causes for the cost outliers are also presented to the user.

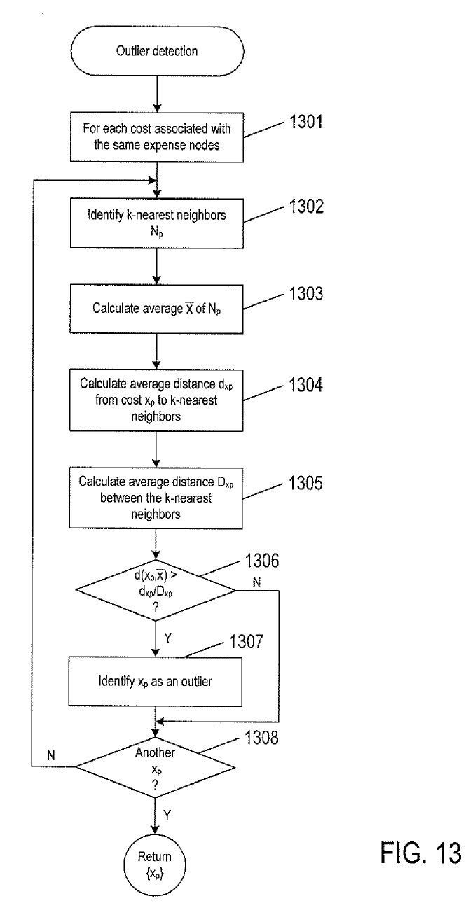

FIG. 13 shows a flow-control diagram for the routine “outlier detection” called in block 1205 of FIG. 12. A for-loop beginning with block 1301 repeats the operations in blocks 1302-1308 for each of the cost in the set of costs associated with the same expense node. In block 1302, k-nearest neighbor costs to a cost xₚ are identified to form a neighborhood Nₚ described above with reference to FIG. 8A. In block 1303, an average x̅ is calculated for the costs in the neighborhood Nₚ, as described above with reference to Equation (3a). In block 1304, an average distance d̅ₓ_{ₚ} from the cost point xₚ to each cost point in the neighborhood Nₚ is calculated according to Equation (3b). In block 1305, an average distance D̅ₓ_{ₚ} between the cost points in the neighborhood are calculated according to Equation (3c). In block 1306, when d(xₚ, x̅) is greater than d̅ₓ_{ₚ}/ D̅ₓ_{ₚ} calculated according to Equation (2), the method proceeds to block 1307. Otherwise, the method proceeds to block 1308. In block 1307, an expense node with d(xₚ, x̅) greater than d̅ₓ_{ₚ}/ D̅ₓ_{ₚ} is identified as a cost outlier. In block 1308, the operations in blocks 1302-1307 are repeated for another cost associated with the expense node over the cost-flow models. Otherwise, the method returns a set of cost outliers.

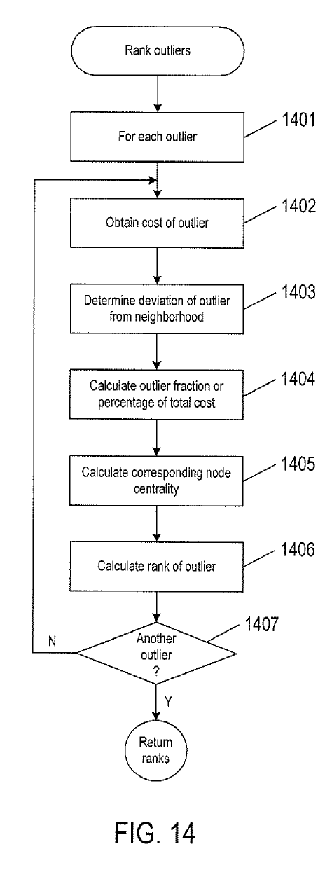

FIG. 14 shows a flow-control diagram for the routine “rank outliers” called in block 1207 of FIG. 12. A for-loop beginning with block 1401 repeats the operations in blocks 1402-1407 for each cost outlier detected in block 1205. In block 1402, a cost outlier Cₒ associated with an expense node Eₒ identified as having a cost outlier is obtained. In block 1403, the distance d(x_{E}_{ₒ}, x̅) is calculated as described above with reference to Equation (2). In block 1404, cost outlier percentage of the total cost is calculated. In block 1405, centrality σ(Eₒ) of the expense node Eₒ associated with cost outlier Cₒ may be calculated according to Equation (6) or Equation (7). In block 1406, rank R(Cₒ) is calculated for the cost outlier according to Equation (5), where the weights are selected by the user. In block 1407, the operations represented by blocks 1402-1406 are repeated for another cost outlier. Otherwise, the method returns the list of rank ordered cost outliers.

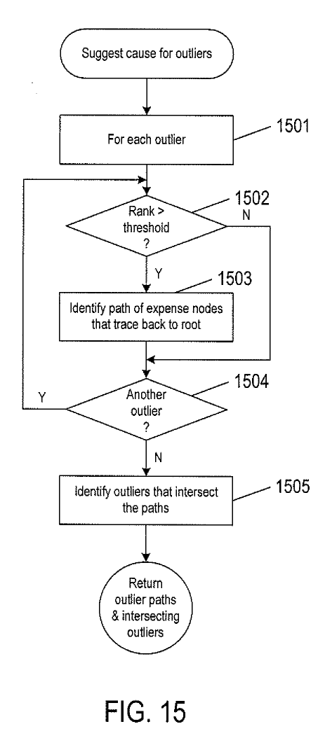

FIG. 15 shows a flow-control diagram for the routine “suggest cause for outliers” called in block 1208 of FIG. 12. A for-loop beginning with block 1501 repeats the operations of blocks 1502-1504 for each cost outlier determined in block 1205 of FIG. 12. In block 1502, when the rank of a cost outlier is greater than a user defined threshold, the method proceeds to block 1503. Otherwise, the method proceeds to block 1504. In block 1503, a path that leads back to a root is identified, as described above with reference to FIGS. 11A-11C. In block 1504, the operations represented by blocks 1502-1503 are repeated for another cost outlier. Otherwise, the method proceeds to block 1505. In block 1505, cost outliers that intersect the paths are identified. The paths and cost outliers that intersect the paths are returned for presentation to a user.

Although the above disclosure has been described in terms of particular embodiments, it is not intended that the disclosure be limited to these embodiments. Modifications within the spirit of the disclosure will be apparent to those skilled in the art. For example, any of a variety of different implementations can be obtained by varying any of many different design and development parameters, including programming language, underlying operating system, modular organization, control structures, data structures, and other such design and development parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for detecting cost outliers in information technology CU″) services purchased by an enterprise, the system comprising:
one or more processors;
one or more data-storage devices; and
a routine stored in the data-storage devices and executed using the one or more processors, the routine
converting bills of IT generated for each billing period into corresponding cost-flow models with expense nodes, each expense node represents a cost for a particular IT services purchased during a billing period;
searching for cost outliers associated with each expense node over the billing periods;
rank ordering the cost outliers;
analyzing the cost outliers in order to identify a possible root cause for each cost outlier; and
storing the rank order and possible cost outliers in a data-storage device.

2. The system of claim 1, wherein searching for cost outliers associated with each expense node over the billing periods further comprises:
for each expense node,
collecting costs over the billing periods to form a set of costs; and
searching the set of costs to detect cost outliers.

3. The system of claim 2, wherein searching the set of costs to detect cost outliers further comprises
for each cost in the set of costs,
identifying nearest cost neighbors of cost;
calculating average of nearest cost neighbors;
calculating average distance from the cost to nearest cost neighbors;
calculating average distance between nearest cost neighbors; and
identifying the cost at an outlier when the distance from the cost to the average of nearest cost neighbors is greater than a ratio of average distance from the cost to nearest cost neighbors to the average distance between nearest cost neighbors.

4. The system of claim 1, wherein rank ordering the cost outliers further comprises calculating a rank of for each outlier based on the cost, distance from the cost to nearest cost neighbors, cost as a percentage of the total cost, and centrality of expense node associated with the cost outlier.

5. The system of claim 1, wherein analyzing the cost outliers in order to identify a possible root cause for each cost outlier further comprise:
tracing a path from an expense node associated with each cost outlier back to a root expense node; and
identifying cost outliers that interest the paths as possible root causes of the cost outlier.

6. A method stored in one or more data-storage devices and executed using one or more processors that detects cost outliers in information technology (“IT”) services purchased by an enterprise, the method comprising:
converting bills of IT generated for each billing period into corresponding cost-flow models with expense nodes, each expense node represents a cost for a particular IT services purchased during a billing period;
searching for cost outliers associated with each expense node over the billing periods;
rank ordering the cost outliers;
analyzing the cost outliers in order to identify a possible root cause for each cost outlier; and
storing the rank order and possible cost outliers in a data-storage device.

7. The method of claim 6, wherein searching for cost outliers associated with each expense node over the billing periods further comprises:
for each expense node,
collecting costs over the billing periods to form a set of costs; and
searching the set of costs to detect cost outliers.

8. The method of claim 7, wherein searching the set of costs to detect cost outliers further comprises
for each cost in the set of costs,
identifying nearest cost neighbors of cost;
calculating average of nearest cost neighbors;
calculating average distance from the cost to nearest cost neighbors;
calculating average distance between nearest cost neighbors; and
identifying the cost at an outlier when the distance from the cost to the average of nearest cost neighbors is greater than a ratio of average distance from the cost to nearest cost neighbors to the average distance between nearest cost neighbors.

9. The method of claim 6, wherein rank ordering the cost outliers further comprises calculating a rank of for each outlier based on the cost, distance from the cost to nearest cost neighbors, cost as a percentage of the total cost, and centrality of expense node associated with the cost outlier.

10. The method of claim 6, wherein analyzing the cost outliers in order to identify a possible root cause for each cost outlier further comprise:
tracing a path from an expense node associated with each cost outlier back to a root expense node; and
identifying cost outliers that interest the paths as possible root causes of the cost outlier.

11. A computer-readable medium encoded with machine-readable instructions that implement a method carried out by one or more processors of a computer system to perform the operations of
converting bills of IT generated for each billing period into corresponding cost-flow models with expense nodes, each expense node represents a cost for a particular IT services purchased during a billing period;
searching for cost outliers associated with each expense node over the billing periods;
rank ordering the cost outliers;
analyzing the cost outliers in order to identify a possible root cause for each cost outlier; and
storing the rank order and possible cost outliers in a data-storage device.

12. The medium of claim 11, wherein searching for cost outliers associated with each expense node over the billing periods further comprises:
for each expense node,
collecting costs over the billing periods to form a set of costs; and
searching the set of costs to detect cost outliers.

13. The medium of claim 12, wherein searching the set of costs to detect cost outliers further comprises
for each cost in the set of costs,
identifying nearest cost neighbors of cost;
calculating average of nearest cost neighbors;
calculating average distance from the cost to nearest cost neighbors;
calculating average distance between nearest cost neighbors; and
identifying the cost at an outlier when the distance from the cost to the average of nearest cost neighbors is greater than a ratio of average distance from the cost to nearest cost neighbors to the average distance between nearest cost neighbors.

14. The medium of claim 11, wherein rank ordering the cost outliers further comprises calculating a rank of for each outlier based on the cost, distance from the cost to nearest cost neighbors, cost as a percentage of the total cost, and centrality of expense node associated with the cost outlier.

15. The medium of claim 11, wherein analyzing the cost outliers in order to identify a possible root cause for each cost outlier further comprise:
tracing a path from an expense node associated with each cost outlier back to a root expense node; and
identifying cost outliers that interest the paths as possible root causes of the cost outlier.
